(19) United States
(12) Patent Application Publication
(10) Pub. No.: US 2023/0375424 A1
(43) Pub. Date: Nov. 23, 2023

(54) SENSOR DEVICE AND METHOD FOR DETECTING THE INTERNAL PRESSURE AND/OR A CHANGE IN THE INTERNAL PRESSURE IN A GAS-TIGHT INTERNAL VOLUME OF A HOUSING COMPONENT

(71) Applicant: Robert Bosch GmbH, Stuttgart (DE)

(72) Inventors: Heribert Weber, Nuertingen (DE); Andreas Scheurle, Leonberg (DE); Peter Schmollngruber, Aidlingen (DE); Thomas Friedrich, Moessingen-Oeschingen (DE)

(21) Appl. No.: 18/247,926

(22) PCT Filed: Nov. 15, 2021
(86) PCT No.: PCT/EP2021/081693

§ 371 Date: Apr. 5, 2023

(30) Foreign Application Priority Data
Nov. 25, 2020 (DE) 102020214757.4

(51) Int. Cl. G01L 9/00; G01L 19/14

(52) U.S. Cl. CPC G01L 9/0072; G01L 19/14

(57) ABSTRACT

A sensor device. The sensor device includes a housing component with a gas-tight internal volume, at least one electrode structure arranged in the internal volume in an adjustable and/or bendable manner, at least one counter electrode fixedly disposed on and/or in the housing component, and an electronic device configured to apply an electrical excitation voltage signal between the electrode structure and the counter electrode such that the at least one electrode structure is set in an oscillating motion relative to the housing component. The electronic device is configured to detect and/or determine the internal pressure in the internal volume and/or a change in the internal pressure while taking into consideration at least one sensor signal, which is dependent on an electric voltage or capacitance between the electrode structure and the counter electrode.

### FIELD

The present invention relates to a sensor device and a production method for a sensor device. The present invention also relates to a method for detecting the internal pressure and/or a change in the internal pressure in a gas-tight internal volume of a housing component and a pressure measurement method.

### BACKGROUND INFORMATION

FIG. 1 shows a schematic illustration of a conventional pressure sensor, which is known to the applicant as internal prior art.

The prior art pressure sensor shown schematically in FIG. 1 comprises a membrane 10, the membrane inner side 10a of which adjoins a gas-tight internal volume 14 that is formed within a housing component 12 of the pressure sensor and has an internal pressure pᵢ. In the event of a pressure difference unequal to zero between the internal pressure pᵢ and a prevailing external pressure pₐ at its membrane outer side 10b, the membrane 10 can be deformed in such a way that a measuring electrode 16 suspended on the membrane inner side 10a can be adjusted. An adjusting movement of the measuring electrode 16 can be detected on the basis of a resulting change in a measuring capacitance kₘ of a measuring capacitor formed by the measuring electrode 16 and an associated measuring counter electrode 18. The conventional pressure sensor also comprises at least one invariable reference electrode 20, which is fixedly disposed on the housing component 12 such that a deformation of the membrane 10 does not (substantially) affect a position/location of the at least one reference electrode 20 with respect to the housing component 12. A reference capacitance kᵣ of a reference capacitor formed by an invariable reference electrode 20 and an associated reference counter electrode 22 is thus not/barely affected by a deformation of the membrane 10. The at least one invariable reference capacitance kᵣ can thus be evaluated in addition to the measuring capacitance kₘ for the determination of the external pressure pₐ while also taking into account a value which is fixedly specified as the internal pressure pᵢ.

The housing component 12 of the conventional pressure sensor shown schematically in FIG. 1 comprises a substrate 24 having a substrate surface 24a which is covered at least partially with a silicon dioxide layer 26 and a silicon-rich silicon nitride layer 28 deposited on top of that. The measuring counter electrode 18 and the at least one reference counter electrode 22 are structured out of a first semiconductor and/or metal layer 30 deposited on the silicon-rich silicon nitride layer 28. The measuring electrode 16 and the at least one reference electrode 20 are structured out of a second semiconductor and/or metal layer 34 which at least partially covers the first semiconductor and/or metal layer 30 and at least one first sacrificial layer 32. The membrane 10, the clamping region of which is outlined with a dashed line 36, is formed from a third semiconductor and/or metal layer 38 which at least partially covers the second semiconductor and/or metal layer 34 and at least one second sacrificial layer 40. The conventional pressure sensor furthermore also comprises an insulating layer 42, which at least partially covers the third semiconductor and/or metal layer 38 and serves to produce a gas-tight seal of the internal volume 14 and on which a metallization 44 is deposited to form a contact region 46 that is covered at least partially with a passivation 48.

### SUMMARY

The present invention provides a sensor device, a method for producing a sensor device, a method for detecting the internal pressure and/or a change in the internal pressure in a gas-tight internal volume of a housing component, and a pressure measurement method.

The present invention provides advantageous options for detecting and/or determining the internal pressure and/or a change in the internal pressure in a gas-tight internal volume of a housing component. Detecting/determining the internal pressure or the change in the internal pressure is often necessary, because it is temperature-dependent and therefore a temperature-dependent counterforce can be applied, e.g., to a membrane inner side, based on the respective internal pressure. The temperature-dependent counterforce can affect a deflection of the membrane and can distort the measurement of an external pressure at the membrane outer side or a change in the external pressure. The greater the internal pressure in the internal volume sealed off by the membrane, the greater the temperature-dependent effect on the internal pressure on the measurement result. Outgassing of a gas from the housing component, for example hydrogen, or aging effects on the gas-tight seals of the housing component often have a significant effect on the internal pressure in the gas-tight internal volume and thus on the measurement accuracy. Due to the progressive miniaturization of devices and micromechanical components, the dimensions of housing components are decreasing more and more, which is why the respective gas-tight internal volume configured therein is becoming smaller and smaller and outgassing effects and aging effects can lead to significantly larger deviations in the internal pressure in the internal volume. The present invention, however, makes it possible to reliably ascertain the internal pressure in the respective internal volume and/or its change and use it to correct the measured external pressure.

In one advantageous embodiment of the sensor device of the present invention, the housing component comprises a deformable membrane with a membrane inner side which adjoins the internal volume and the sensor device comprises a measuring electrode which is suspended on the membrane inner side and at least one measuring counter electrode which is fixedly disposed on and/or in the housing component, wherein the electronic device is additionally designed and/or programmed to detect or determine the external pressure at a membrane outer side of the membrane facing away from the membrane inner side and/or a change in the external pressure while taking into account at least one measurement signal, which is dependent on an electrical voltage or capacitance between the suspended measuring electrode and the single measuring counter electrode or at least one of the measuring counter electrodes, and the determined internal pressure and/or the determined change in the internal pressure. The here-described embodiment of the sensor device can thus advantageously be used as a pressure sensor for measuring an external pressure/ambient pressure or a change to said pressure. The here-described embodiment of the sensor device makes it possible to determine/measure the external pressure more accurately and with less errors in the long term based on the accurate and reliable knowledge of the internal pressure and/or the change in the internal pressure relative to the time at which an electronic adjustment of the pressure sensor took place.

According to an example embodiment of the present invention, as the at least one counter electrode, the sensor device preferably comprises a respective first counter electrode disposed on a side of the at least one adjustable and/or bendable electrode structure facing away from the membrane adjacent to the at least one electrode structure and a respective second counter electrode disposed on a side of the at least one electrode structure facing the membrane adjacent to the at least one electrode structure, and wherein the electronic device is designed and/or programmed to form a difference signal from a first sensor signal, which is dependent on a first electrical voltage or capacitance between the at least one electrode structure and the first counter electrode, and a second sensor signal, which is dependent on a second electrical voltage or capacitance between the at least one electrode structure and the second counter electrode. An evaluation of the difference signal obtained in this manner enables a more accurate and reliable determination of the internal pressure in the internal volume and/or the change in the internal pressure.

According to an example embodiment of the present invention, as the at least one measuring counter electrode, the sensor device can alternatively or additionally comprise a first measuring counter electrode disposed on a side of the suspended measuring electrode facing away from the membrane adjacent to the suspended measuring electrode and a second measuring counter electrode disposed on a side of the suspended measuring electrode facing the membrane adjacent to the suspended measuring electrode, wherein the electronic device is designed and/or programmed to form a difference measurement signal from a first measurement signal, which is dependent on an electrical voltage or capacitance between the suspended measuring electrode and the first measuring counter electrode, and a second measurement signal, which is dependent on an electrical voltage or capacitance between the suspended measuring electrode and the second measuring counter electrode. Forming the difference measurement signal in the above-described manner likewise makes it possible to improve the measurement sensitivity and/or measurement accuracy when determining the external pressure. The measurement sensitivity and/or the measurement accuracy of the measured external pressure can be improved by using the measured internal pressure and/or the measured change in the internal pressure and also the currently prevailing ambient temperature to adjust/correct the ascertained external pressure.

According to an example embodiment of the present invention, the housing component preferably comprises a substrate, wherein the at least one first counter electrode and the first measuring counter electrode are structured out of a first semiconductor and/or metal layer deposited on a substrate surface of the substrate and/or at least one intermediate layer which at least partially covers the substrate surface, the at least one adjustable and/or bendable electrode structure and the suspended measuring electrode are structured out of a second semiconductor and/or metal layer deposited on the first semiconductor and/or metal layer and/or at least one first sacrificial layer which at least partially covers the first semiconductor and/or metal layer, the at least one second counter electrode and the second measuring counter electrode are structured out of a third semiconductor and/or metal layer deposited on the second semiconductor and/or metal layer and/or at least one second sacrificial layer which at least partially covers the second semiconductor and/or metal layer and the membrane is formed from a fourth semiconductor and/or metal layer deposited on the third semiconductor and/or metal layer and/or at least one third sacrificial layer which at least partially covers the third semiconductor and/or metal layer. The here-described embodiment of the sensor device is cost-efficient and can be produced by carrying out easily-implementable method steps while at the same time maintaining an advantageous level of accuracy.

In a further advantageous embodiment of the sensor device of the present invention, in an acceleration and/or rotation rate measurement mode, the electronic device is designed and/or programmed to determine at least one sensor variable relating to the acceleration and/or the rotation rate of the sensor device during an acceleration and/or rotation of the sensor device taking into account the at least one sensor signal. The here-described embodiment of the sensor device can thus also be used as an acceleration sensor and/or as a rotation rate sensor, wherein the multifunctionality of its at least one electrode structure makes it easy to miniaturize the sensor device, despite its versatility.

The above-described advantages can also be realized by carrying out a corresponding production method for a sensor device. Carrying out a corresponding method for measuring an internal pressure in a gas-tight internal volume of a housing component likewise provides the above-described advantages. The above-described advantages are furthermore also ensured when a corresponding pressure measurement method is carried out. It is expressly noted that the methods listed here can be further developed in accordance with the embodiments of the sensor device discussed above.

### BRIEF DESCRIPTION OF THE DRAWINGS

Further features and advantages of the present invention are explained in the following with reference to the figures.

FIG. 1 shows a schematic illustration of a conventional pressure sensor.

FIGS. 2A and 2B show a schematic illustration of a first embodiment of the sensor device and a coordinate system for explaining its mode of operation, according to the present invention.

FIG. 3 shows a schematic partial view of a second embodiment of the sensor device, according to the present invention.

FIG. 4 shows a schematic partial view of a third embodiment of the sensor device, according to the present invention.

FIG. 5 shows a schematic partial view of a fourth embodiment of the sensor device, according to the present invention.

FIG. 6 shows a schematic illustration of a fourth embodiment of the sensor device, according to the present invention.

FIG. 7 shows a schematic illustration of a sixth embodiment of the sensor device, according to the present invention.

FIG. 8 shows a schematic illustration of a seventh embodiment of the sensor device, according to the present invention.

FIGS. 9A and 9B show schematic overall and partial views of an eighth embodiment of the sensor device, according to the present invention.

FIG. 10 shows a flow chart for explaining an embodiment of the production method for a sensor device, according to the present invention.

FIG. 11 shows a flow chart for explaining an embodiment of a method for measuring an internal pressure in a gas-tight internal volume of a housing component.

### DETAILED DESCRIPTION OF EXAMPLE EMBODIMENTS

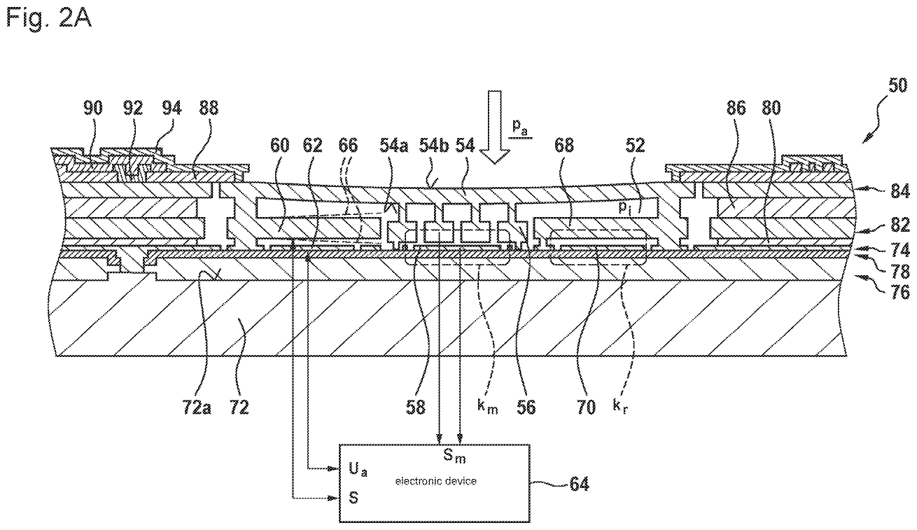

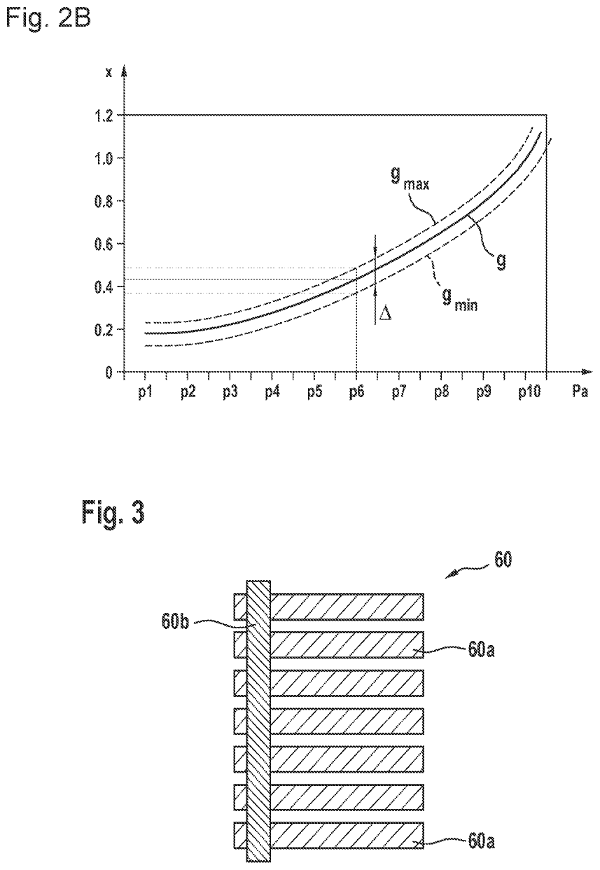

FIGS. 2A and 2B show a schematic illustration of a first embodiment of the sensor device and a coordinate system for explaining its mode of operation.

The sensor device shown schematically in FIG. 2A can be used as a pressure sensor. For this purpose, the sensor device comprises a housing component 50 with a gas-tight internal volume 52 configured therein and with a deformable membrane 54, the membrane inner side 54a of which adjoins the internal volume 52. The membrane 54 can be deformed by a pressure difference (unequal to zero) between the internal pressure pᵢ in the gas-tight internal volume 52 and the external pressure pₐ at its membrane outer side 54b facing away from the membrane inner side 54a. A measuring electrode 56 is suspended on the membrane inner side 54a such that the measuring electrode 56 is or can be adjusted by a deformation of the membrane 54 relative to at least one measuring counter electrode 58 which is fixedly disposed on and/or in the housing component 50. The suspended measuring electrode 56 can be understood to be either a single measuring electrode 56 or at least two/multiple individual electrodes suspended on the membrane inner side 54a. The at least one measuring counter electrode 58 can correspondingly likewise include a single measuring counter electrode 58 or at least two/multiple individual electrodes fixedly disposed on and/or in the housing component 50. The fixed placement of the at least one measuring counter electrode 58 is intended to be understood to mean that the at least one measuring counter electrode 58 is not/barely adjustable or bendable (without damaging the sensor device).

By evaluating a measuring capacitance kₘ of at least one measuring capacitor formed by the measuring electrode 56 and the at least one measuring counter electrode 58, the external pressure pₐ can thus be detected and/or determined/measured relative to or with reference to the enclosed internal pressure pᵢ in the internal volume 52. A change in the external pressure pₐ relative to a predetermined external pressure value can correspondingly be detected and/or determined/measured by means of the evaluation of the measuring capacitance kₘ as well. A detected or determined change in the internal pressure pᵢ relative to a predetermined internal pressure value can also be used to detect and/or determine/measure the external pressure pₐ and/or the change in the external pressure pₐ.

To accurately and reliably detect and/or determine/measure the internal pressure pᵢ in the gas-tight internal volume 52 and/or the change in the internal pressure pᵢ (relative to the predetermined internal pressure value), the sensor device also comprises at least one electrode structure 60 which is disposed in the internal volume 52 in an adjustable and/or bendable manner. The sensor device moreover also comprises at least one counter electrode 62 which is fixedly disposed on and/or in the housing component 50. This is intended to be understood to mean that the at least one counter electrode 62 is not/barely adjustable or bendable (without damaging the sensor device). The sensor device additionally comprises an electronic device 64 which is designed and/or programmed to apply at least one electrical excitation voltage signal Uₐ between the at least one adjustable or bendable electrode structure 60 and the single counter electrode or at least one of the counter electrodes 62 such that the at least one electrode structure 60 is set in an oscillating motion (shown with the dashed lines 66) relative to the housing component 50. The oscillating motion of the at least one electrode structure 60 can be understood to be both a bending oscillating motion and an adjusting oscillating motion. The electronic device 64 is furthermore also designed and/or programmed to detect and/or determine the internal pressure pᵢ in the internal volume 52 and/or the change thereof while taking into account at least one sensor signal S which is dependent on an electrical voltage or capacitance between the at least one electrode structure 60 and the single counter electrode or at least one of the counter electrodes 62. The at least one sensor signal S can be a sensor capacitance of a sensor capacitor formed from the at least one electrode structure 60 and the at least one counter electrodes 62, for example.

The here-described sensor device thus utilizes the at least one electrode structure 60 as an oscillatable structure within the internal volume 52 for detecting the internal pressure pᵢ and/or the change in the internal pressure pᵢ (relative to the predetermined internal pressure value) in the internal volume 52. Since an oscillatable structure often already exists or is structurally easy to implement in the internal volume 52, the advantageous additional function of the sensor device described in the preceding paragraph can easily be implemented with a minor structural modification and/or by programming the electronic device 64. The electronic device 64 can advantageously utilize the knowledge of the internal pressure pᵢ and/or the change in the internal pressure pᵢ to reliably detect and/or more accurately determine the external pressure pₐ and/or the change in the external pressure pₐ. For this purpose, the electronic device 64 in the example of FIGS. 2A and 2B is designed and/or programmed to take into account not only at least one measurement signal Sₘ, which is dependent on an electrical voltage or the measuring capacitance kₘ between the suspended measuring electrode 56 and the single measuring counter electrode or at least one of the measuring counter electrodes 58, but also the internal pressure pᵢ and/or the change in the internal pressure pᵢ when detecting/determining the external pressure pₐ and/or the change in the external pressure pₐ.

To detect/determine the internal pressure pᵢ and/or the change in the internal pressure pᵢ in the internal volume 52, at least one parameter x representing the oscillating motion of the at least one electrode structure 60, for example, can be established first while taking into account the at least one sensor signal S. The at least one parameter x can, for example, be a quality of the oscillating motion, a resonance frequency of the oscillating motion, a damping of the oscillating motion, a signal rise time of the at least one sensor signal S and/or a signal fall time of the at least one sensor signal S. The internal pressure pᵢ in the internal volume 52 and/or the change thereof can then be determined/measured taking into account the at least one parameter x.

FIG. 2B shows a coordinate system, the abscissa of which describes the external pressure pₐ and the ordinate of which describes a parameter x of the oscillating motion of the at least one electrode structure 60 caused by means of the at least one electrical excitation voltage signal Uₐ. The parameter x of the oscillating motion of the at least one electrode structure 60 can, for example, be a quality of the oscillating motion, a resonance frequency of the oscillating motion, a damping of the oscillating motion, a signal rise time of the at least one sensor signal S or a signal fall time of the at least one sensor signal S. As can be seen from the coordinate system of FIG. 2B, a change in the external pressure pₐ due to the resulting membrane deformation of the membrane 54 causes an increase or decrease in the internal pressure pᵢ in the internal volume 52 and thus also a change in the parameter x of the oscillating motion (solid black line). In a first adjustment of the sensor device, for example, a relationship between the parameter x of the oscillating motion and the external pressure pₐ applied as a function of the ambient temperature can be recorded in a parameter field. However, as also indicated by the arrow Δ in FIG. 2B, outgassing effects and aging effects can change the internal pressure pᵢ in the internal volume 52 as well. In particular due to outgassing effects and/or aging effects, a graph g showing the relationship between the external pressure pₐ and the parameter x varies between a minimum graph grain and a maximum graph gₘₐₓ.

As can also be seen from the coordinate system of FIG. 2B, an accurate and reliable determination/measurement of the external pressure pₐ at the membrane outer side 54b requires accurate and error-free knowledge of the internal pressure pᵢ and/or the change in the internal pressure pᵢ within the gas-tight internal volume 52. Since the internal pressure pᵢ and/or the change in the internal pressure pᵢ within the internal volume 52 can be reliably ascertained using the here-described sensor device, the external pressure pₐ can consequently be determined with a higher measurement accuracy, with a higher long-term stability of the measurement accuracy and with a reduced error deviation using the sensor device than in the prior art.

By measuring the internal pressure pᵢ in the internal volume 52, the sensor device can promptly detect a non-reversible change in the internal pressure pᵢ in the internal volume 52 relative to the time of the first adjustment of the sensor device. This monitoring of the internal pressure pᵢ in the internal volume 52 makes it possible to correct a measured value determined as the external pressure pₐ if a deviation of the internal pressure pᵢ from a predefined “normal value” is observed. If the sensor device also comprises a temperature sensor or a device for measuring temperature, a deviation of the internal pressure pᵢ from the predetermined “normal value” can be precisely determined. The “normal value” can be understood here as a value in a parameter field ascertained during an adjustment of the sensor device, e.g. a pressure sensor.

It is thus possible to determine whether the deviation of the internal pressure pᵢ correlates to a change in the external pressure pₐ, for example, or whether, because of outgassing and/or aging effects, an adjustment of the measured value describing the external pressure pₐ should be considered. Another significant advantage of the here-described sensor device is that, since the internal pressure pᵢ and/or the change in the internal pressure pᵢ in the internal volume 52 can be determined repeatedly even over a long service life of the sensor device and used to adjust/correct the ascertained value for the external pressure pₐ, precise measurements of the external pressure pₐ by means of the sensor device are possible in the long term as well.

Since the internal pressure pᵢ does not have to be measured continuously, the at least one electrode structure 60 can also be used for other purposes. For example, shocks to the sensor device/its housing component 50 can be detected/identified by means of the at least one electrode structure 60 and its at least one counter electrode 62. The electronic device 64 can alternatively or additionally also be designed and/or programmed to determine at least one sensor variable relating to the acceleration and/or the rotation rate of the sensor device during an acceleration and/or rotation of the sensor device taking into account the at least one sensor signal, or to measure at least one corresponding measured value. This, too, can be accomplished by evaluating the at least one sensor signal S. Appropriate design of the at least one electrode structure 60 and its at least one counter electrode 62 makes it possible to ensure that shocks to the sensor device, linear accelerations of the sensor device and/or rotational accelerations of the sensor device cause the at least one electrode structure 60 to carry out movements which can extend or are oriented perpendicular to the membrane inner side 54a and/or the membrane outer side 54b and/or parallel to the membrane inner side 54a and/or the membrane outer side 54b and are detected using the at least one counter electrode 62.

To minimize the risk of a measurement error resulting from shocks to the sensor device, linear accelerations of the sensor device or rotational accelerations of the sensor device when determining/measuring the internal pressure pᵢ and/or the change in the internal pressure pᵢ, the determination/measurement of the internal pressure pᵢ and/or the change in the internal pressure pᵢ is preferably carried out at a point in time at which the at least one electrode structure 60 is in a state in which it is not excited from the outside.

As an optional further development, the sensor device of FIGS. 2A and 2B also comprises at least one reference electrode 68 and at least one reference counter electrode 70, wherein the electrodes 68 and 70 are fixedly disposed on and/or in the housing component 50 such that at least one reference capacitance kᵣ of a reference capacitor formed by the at least one reference electrode 68 and its at least one reference counter electrode 70 is (substantially) unaffected even by a strong deformation of the membrane 54 and can be considered constant or invariable. The electronic device 64 can also be designed and/or programmed to take into account the at least one reference capacitance kᵣ or a reference signal corresponding to said reference capacitance when determining/measuring the external pressure pₐ and/or the change in the external pressure pₐ. After the internal volume 14 is closed in a gas-tight manner, the capacitance value of the at least one reference capacitance kᵣ and the measuring capacitance kₘ are preferably the same size.

The sensor device shown schematically in FIG. 2A comprises a substrate 72 having a substrate surface 72a, e.g. a silicon substrate, preferably in the form of a wafer. The at least one counter electrode 62 and possibly also the measuring counter electrode 58 and/or the at least one reference counter electrode 70 are structured out of a first semiconductor and/or metal layer 74, which is deposited on the substrate surface 72a and/or at least one intermediate layer 76 and 78 that at least partially (directly) covers the substrate surface 72a. The at least one intermediate layer 76 and 78 can be a silicon dioxide layer 76 and a silicon-rich silicon nitride layer 78 deposited on top of it, for example. The at least one electrode structure 60 and possibly also the measuring electrode 56 and/or the at least one reference electrode 68 are structured out of a second semiconductor and/or metal layer 82 which at least partially (directly) covers the first semiconductor and/or metal layer 74 and/or at least one first sacrificial layer 80. The membrane 54 is moreover formed from a further semiconductor and/or metal layer 84 which at least partially (directly) covers the second semiconductor and/or metal layer 82 and/or at least one second sacrificial layer 86. A silicon layer can respectively be deposited as the first semiconductor and/or metal layer 74, the second semiconductor and/or metal layer 82 and/or the further semiconductor and/or metal layer 84, for example, and can also be provided with a dopant to achieve a higher electrical conductivity. The at least one first sacrificial layer 80 and/or the at least one further sacrificial layer 86 can each be at least one silicon dioxide layer, for example. At least in the clamping region 36, an electrical contact/connection can be formed partially or in some areas between the first semiconductor and/or metal layer 74, the second semiconductor and/or metal layer 82, and/or the third semiconductor and/or metal layer 84. Suitable electrical contacts/connections can in particular be disposed in the region of electrode structures.

The further semiconductor and/or metal layer 84 is moreover covered at least partially (directly) with at least one insulating layer 88, such as a silicon dioxide layer, which is used to close the internal volume 52 in a gas-tight manner and to enclose the defined internal pressure pᵢ in the internal volume 52 and on which a metallization 90 is deposited to form a contact region 92. The metallization 90 can in particular be aluminum copper. The metallization 90 can additionally be covered with a passivation 94, such as in particular silicon nitride.

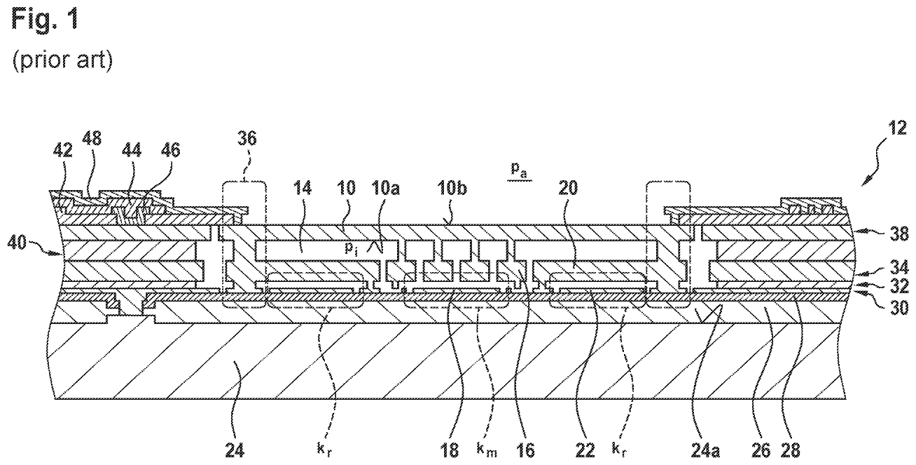

As can also be seen from a comparison of FIGS. 1 and 2A, the at least one electrode structure 60 can be implemented with a slight structural modification instead of a conventional reference electrode 20. For this purpose, an anchoring on at least one of the conventional reference electrodes 20 can be omitted/eliminated, for example, which respectively makes it possible to realize the bendable electrode structure 60. An anchoring of the respective conventional reference electrodes 20 facing the suspended measuring electrode 56 can in particular be omitted/eliminated so that an end facing the suspended measuring electrode 56 is free-standing. This has the effect that the free-standing end of the respective electrode structure 60 excited to oscillating motion by the at least one electrical excitation voltage signal Uₐ oscillates with a maximum amplitude.

FIG. 3 shows a schematic partial view of a second embodiment of the sensor device.

Of the sensor device of FIG. 3, only the at least one electrode structure 60 which comprises a plurality of bending beam structures 60a, the ends of which facing the suspended measuring electrode 56 are free-standing, while their ends facing away from the suspended measuring electrode 56 are connected to one another on a connecting beam 60b, is depicted as an example. The connecting beam 60b can in particular be part of a system for clamping the membrane 54.

With regard to further properties and features of the sensor device of FIG. 3 and its advantages, reference is made to the description of FIGS. 2A and 2B.

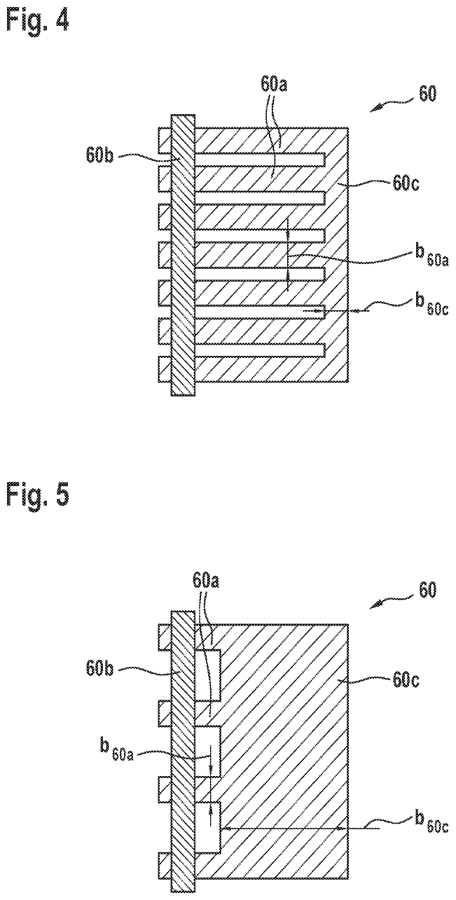

FIG. 4 shows a schematic partial view of a third embodiment of the sensor device.

As a further development with respect to the sensor device of FIG. 3, in the sensor device of FIG. 4 the ends of the bending beam structures 60a of the at least one electrode structure 60 facing the suspended measuring electrode 56 are connected to one another via a further connecting beam 60c. A width b_{60c} of the connecting beam 60c can be equal to a width b₆₀ₐ of the bending beam structure 60a or different.

With regard to further properties and features of the sensor device of FIG. 4 and its advantages, reference is made to the descriptions of FIGS. 2 and 3.

FIG. 5 shows a schematic partial view of a fourth embodiment of the sensor device.

The only difference of the sensor device of FIG. 5 is that the further connecting beam 60c in the sensor device of FIG. 5 has a width b_{60c} which is larger than the width b₆₀ₐ of the bending beam structures 60a by at least a factor of 2.

With regard to further properties and features of the sensor device of FIG. 5 and its advantages, reference is made to the descriptions of FIGS. 2 to 4.

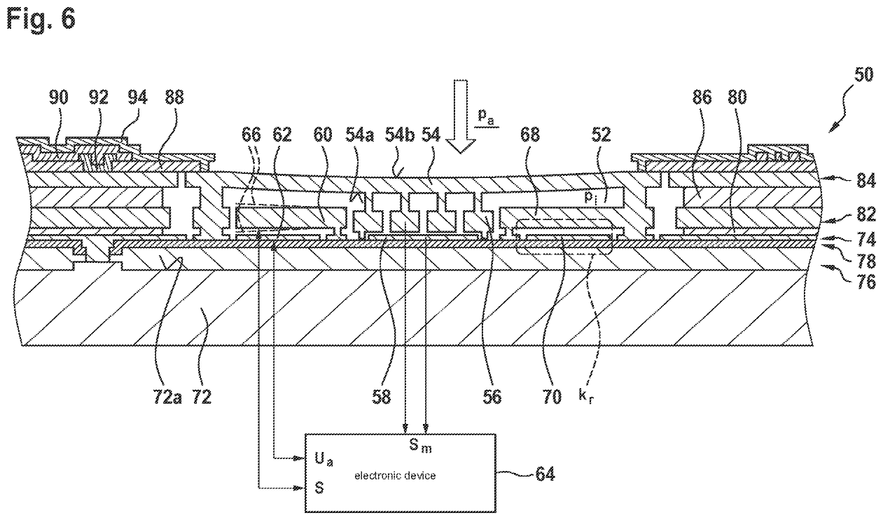

FIG. 6 shows a schematic illustration of a fourth embodiment of the sensor device.

As can be seen when comparing FIGS. 1 and 6, the at least one electrode structure 60 of the sensor device of FIG. 6 is configured by omitting/eliminating an anchoring of the conventional reference electrode 20 facing away/farthest away from the suspended measuring electrode 56 such that an end of the respective electrode structure 60 excited to oscillating motion by the at least one electrical excitation voltage signal Uₐ which faces away from the suspended measuring electrode 56 oscillates with a maximum amplitude. In this embodiment, the maximum amplitude of the deflection of the respective electrode structure 60 is at the end of the respective electrode structure 60 which faces the anchoring structure 36 of the membrane 54.

With regard to further properties and features of the sensor device of FIG. 6 and its advantages, reference is made to the descriptions of FIGS. 2 to 5.

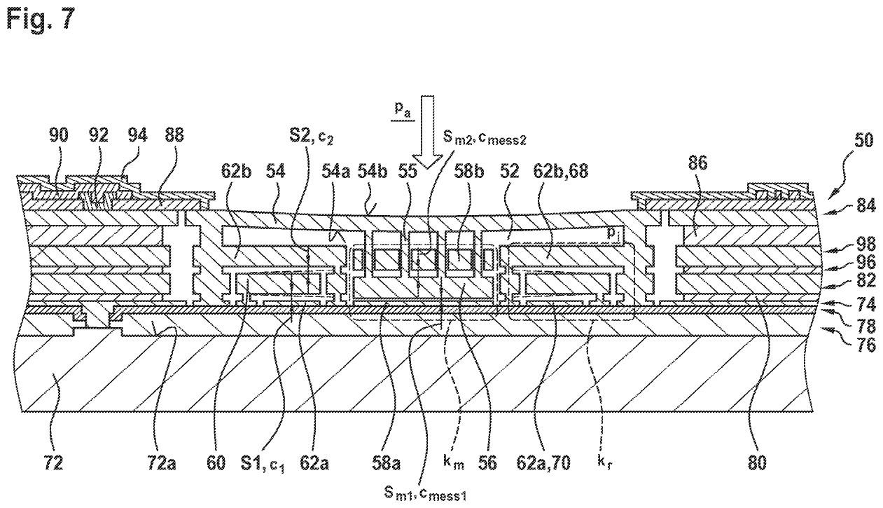

FIG. 7 shows a schematic illustration of a sixth embodiment of the sensor device.

As the at least one counter electrode 62a and 62b, the sensor device of FIG. 7 comprises a first counter electrode 62a disposed on a side of the at least one electrode structure 60 facing away from the membrane 54 (adjacent to the at least one electrode structure 60) and a second counter electrode 62b disposed on a side of the at least one electrode structure 60 facing the membrane 54 (adjacent to the at least one electrode structure 60). The sensor capacitor structure formed in this way is thus implemented as a differential capacitor. Such a differential capacitor has the advantage of being able to achieve higher measurement accuracy and higher measurement sensitivity. The electronic device 64 (not depicted in FIG. 7 for the sake of clarity) is accordingly designed and/or programmed to form a difference signal S1-S2 from a first sensor signal S1, which is dependent on a first electrical voltage or capacitance c₁ between the at least one electrode structure 60 and the at least one first counter electrode 62a, and a second sensor signal S2, which is dependent on a second electrical voltage or capacitance c₂ between the at least one electrode structure 60 and the at least one second counter electrode 62b. Using the difference signal S1-S2, the oscillating motion of the at least one electrode structure 60 can be reliably detected and easily evaluated to determine the internal pressure pᵢ and/or the change in the internal pressure pᵢ in the internal volume 52. The electronic device 64 can optionally also be designed and/or programmed to ascertain a constant comparison value which is independent of the oscillation behavior of the at least one electrode structure 60 by forming a sum signal S1+S2 from the first sensor signal S1 and the second sensor signal S2. The at least one first counter electrode 62a and the at least one second counter electrode 62b can also be used as a reference capacitor for determining the reference capacitance kᵣ. It is also possible to determine the oscillation behavior of the at least one electrode structure 60 by applying an electrical voltage between the at least one counter electrode 62a and the at least one electrode structure 60, with which a deflection of the at least one electrode 60 is achieved. For this purpose, the capacitance c₂ between the at least one electrode structure 60 and the at least one second counter electrode 62b can be used to detect the position of the at least one electrode structure 60. Alternatively, it is also possible to apply an electrical voltage between the at least one second counter electrode 62b and the at least one electrode structure 60 to deflect the at least one electrode structure 60 and use the change in the capacitance value of the capacitance c₁ as a measure of the deflection of the at least one electrode structure 60.

As the at least one measuring counter electrode 58a and 58b, the sensor device of FIG. 7 additionally comprises a first measuring counter electrode 58a disposed on a side of the suspended measuring electrode 56 facing away from the membrane 54 (adjacent to the suspended measuring electrode 56) and a second measuring counter electrode 58b disposed on a side of the suspended measuring electrode 56 facing the membrane 54 (adjacent to the suspended measuring electrode 56). In the sensor device of FIG. 7, the suspended measuring electrode 56 is thus likewise part of a differential capacitor arrangement. The measuring electrode 56 can in particular be suspended on the membrane inner side 54a of the membrane 54 via at least one connecting strand 55 which extends through an opening in the second measuring counter electrode 58b. The electronic device 64 is therefore also designed and/or programmed to form a difference measurement signal Sₘ₁-Sₘ₂ from a first measurement signal Sₘ₁ relating to an electrical voltage or capacitance C_{mess 1} between the suspended measuring electrode 56 and the first measuring counter electrode (58a) and from a second measurement signal Sₘ₂ relating to an electrical voltage or capacitance c_{mess 2} between the suspended measuring electrode 56 and the second measuring counter electrode 58b. Forming the difference measurement signal Sₘ₁-Sₘ₂ makes it possible to detect the position of the suspended measuring electrode 56 which reflects a deformation/deflection of the membrane 54. The electronic device 64 can optionally also be designed and/or programmed to determine the total capacitance c_{mess 1}+C_{mess 2} of the measuring capacitor by forming a sum measurement signal Sₘ₁+Sₘ₂ from the first measurement signal Sₘ₁ and the second measurement signal Sₘ₂.

In the sensor device of FIG. 7, too, the housing component 50 comprises the substrate 72. The at least one first counter electrode 62a and/or the first measuring counter electrode 58a are structured out of the first semiconductor and/or metal layer 74. The at least one second counter electrode 62b and the second measuring counter electrode 58b are structured out of a third semiconductor and/or metal layer 98 deposited (directly) on the second semiconductor and/or metal layer 82 and/or at least one second sacrificial layer 96 which at least partially covers the second semiconductor and/or metal layer 82. Inserting the third semiconductor and/or metal layer 98 as an additional functional layer makes it easy to implement the differential capacitances/differential capacitance structures.

The above-described differential capacitances/differential capacitance structures also eliminate the need for a conventionally often necessary “large area” arrangement of reference capacitor structures that can, for instance, be used for an external pressure measurement using a Wheatstone bridge circuit. The insertion of the third semiconductor and/or metal layer 98 and the configuration of differential capacitances thus facilitate miniaturization of the sensor device of FIG. 7.

In the differential measuring capacitor structure shown in FIG. 7, an adjusting movement of the suspended measuring electrode 56 causes a change in the capacitance cₘₑₛₛ₁ between the suspended measuring electrode 56 and the first measuring counter electrode 58a and an opposite change in the capacitance cₘₑₛₛ₂ between the suspended measuring electrode 56 and the second measuring counter electrode 58b. It is therefore possible to connect a first partial capacitor structure of the differential measuring capacitor consisting of the suspended measuring electrode 56 and the first measuring counter electrode 58a and a second partial capacitor structure of the differential measuring capacitor consisting of the suspended measuring electrode 56 and the second measuring counter electrode 58b together to two reference capacitance structures kᵣ in a Wheatstone bridge arrangement. In this way, a so-called half-bridge is obtained. If two identically structured sensor devices are connected to a respective differential measuring capacitor structure in a Wheatstone bridge arrangement, a so-called full-bridge having a maximum measurement sensitivity and a measured value or bridge signal twice as large as that of a half-bridge arrangement is obtained.

It is also advantageous to reduce a distance between the third semiconductor and/or metal layer 98 and the second semiconductor and/or metal layer 82 in the region of the later second measuring counter electrode 58b in order to ensure equally large capacitance values for the capacitance cₘₑₛₛ₁ between the suspended measuring electrode 56 and the first measuring counter electrode 58a and the capacitance cₘₑₛₛ₂ between the suspended measuring electrode 56 and the second measuring counter electrode 58b at the time of the electrical adjustment of the sensor device. Since the internal pressure pᵢ in the internal volume 52 is generally significantly lower than the external pressure pₐ, the pressure difference between the external pressure pₐ and the internal pressure pᵣ leads to a deformation of the membrane 54 and an increase of cₘₑₛₛ₁ relative to cₘₑₛₛ₂ To ensure that there is no offset in the measurement of the electrical bridge voltage at the time of the adjustment of the sensor device with an existing external pressure pₐ and a corresponding deformation of the membrane 54 (the bridge voltage is equal to zero), the distance between the suspended measuring electrode 56 and the first measuring counter electrode 58a can be adjusted accordingly by at least locally adjusting the layer thickness of the second sacrificial layer 96 as described above.

With regard to further properties and features of the sensor device of FIG. 7 and its advantages, reference is made to the descriptions of FIGS. 2 to 6.

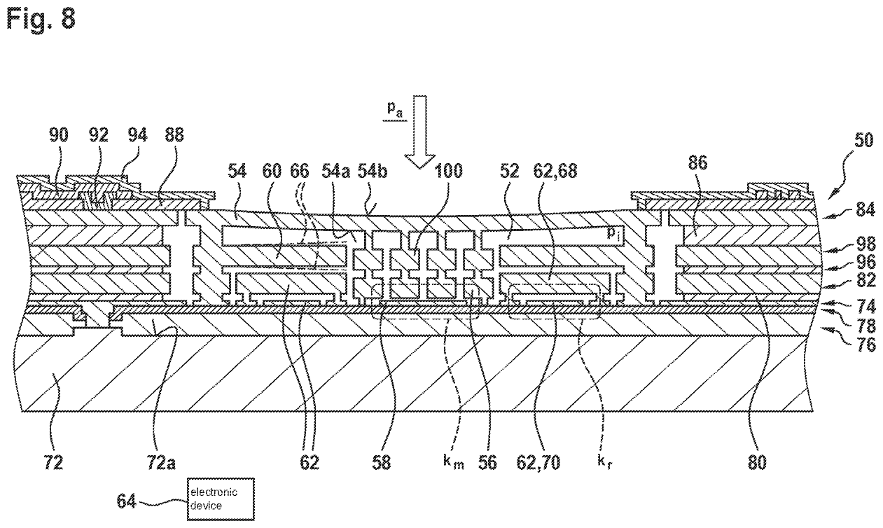

FIG. 8 shows a schematic illustration of a seventh embodiment of the sensor device.

The sensor device of FIG. 8 comprises two counter electrodes 62 disposed on a side of the at least one electrode structure 60 facing away from the membrane 54. In addition, the suspended measuring electrode 56 of the sensor device of FIG. 8 comprises at least one stiffening structure 100 on its side facing the membrane 54. One each of the counter electrodes 62 and/or the measuring counter electrode 58 are structured out of the first semiconductor and/or metal layer 74, while another one of the counter electrodes 62 and/or the suspended measuring electrode 56 are formed from the second semiconductor and/or metal layer 82. The at least one electrode structure 60 and/or the at least one stiffening structure 100 are structured out of the third semiconductor and/or metal layer 98. In this embodiment example, the counter electrodes 62 form at least one reference capacitance, which is disposed between the at least one electrode structure 60 and the intermediate layer 78. By applying at least one electrical excitation voltage signal Uₐ between the at least one electrode structure 60 and the adjacent at least one counter electrode 62, the at least one electrode structure 60 can be set in an oscillating motion relative to the housing component 50.

With regard to further properties and features of the sensor device of FIG. 8 and its advantages, reference is made to the descriptions of FIGS. 2 to 7.

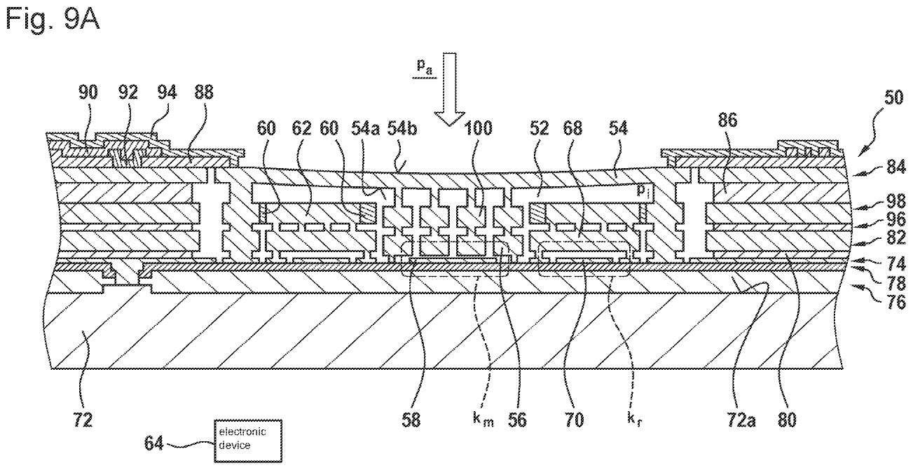

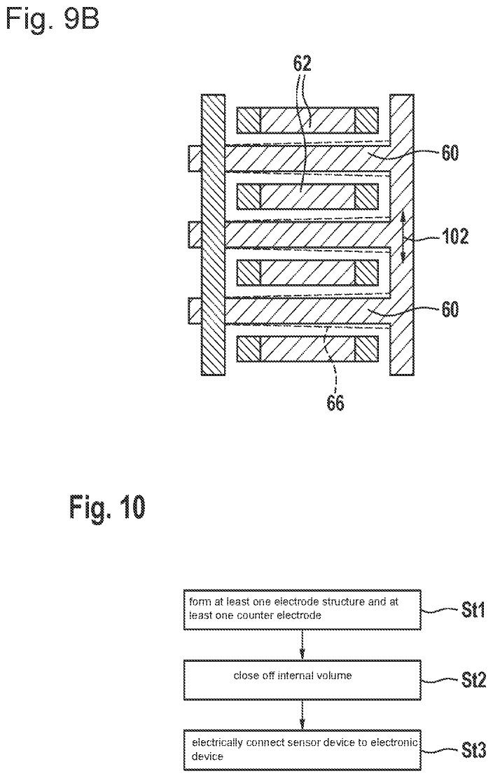

FIGS. 9A and 9B show schematic overall and partial views of an eighth embodiment of the sensor device.

In the sensor device of FIGS. 9A and 9B, the at least one electrode structure 60 is configured as an electrode comb, wherein the counter electrodes 62 are disposed in the spaces between the adjacent electrode fingers of the electrode comb. In this case, the at least one electrical excitation voltage signal Uₐ between the at least one electrode structure 60 and the counter electrodes 62 can be used to set the at least one electrode structure 60 in an oscillating motion parallel to the substrate surface 72a indicated by the arrow 102. The at least one electrode structure 60 and the counter electrodes 62 are structured out of the third semiconductor and/or metal layer 98 as well. The counter electrodes 62 can moreover be at least partially electrically connected to the second semiconductor and/or metal layer 82. As an alternative to the embodiment example shown in FIG. 9B, there can also be two counter electrodes 62 in the spaces between the adjacent electrode fingers of the electrode comb. This facilitates the oscillation excitation of the at least one electrode structure 60 and the measurement of the resulting oscillation curve of the at least one electrode structure 60.

With regard to further properties and features of the sensor device of FIGS. 9A and 9B and their advantages, reference is made to the descriptions of FIGS. 2 to 8.

FIG. 10 shows a flow chart for explaining an embodiment of the production method for a sensor device.

In a method step St1, at least one electrode structure of the later sensor device is formed, which is disposed in an adjustable and/or bendable manner in an internal volume of a housing component of the later sensor device. Also in method step St1, at least one counter electrode of the later sensor device is formed, which is fixedly disposed on and/or in the housing component. In a further method step St2, the internal volume is closed off in a gas-tight manner.

In a method step St3, the sensor device is electrically connected to an electronic device of the later sensor device, which is designed and/or programmed to apply at least one electrical excitation voltage signal between the at least one adjustable or bendable electrode structure and the single counter electrode or at least one of the counter electrodes such that the at least one electrode structure is set in an oscillating motion relative to the housing component. The electronic device is also designed and/or programmed to detect and/or determine the internal pressure in the internal volume and/or a change in the internal pressure while taking into account at least one sensor signal which is dependent on an electrical voltage or capacitance between the at least one electrode structure and the single counter electrode or at least one of the counter electrodes. The advantages of the sensor device produced by means of at least the method steps St1 to St3 have already been discussed above.

Preferably, in method step St1, a deformable membrane with a membrane inner side which adjoins the internal volume is formed as part of the housing component, wherein (at least) one measuring electrode which is suspended on the membrane inner side and at least one measuring counter electrode which is fixedly disposed on and/or in the housing component are formed as well. In this case, the electronic device can also be designed and/or programmed in method step St3 to detect and/or determine the external pressure at a membrane outer side of the membrane facing away from the membrane inner side and/or a change in the external pressure while taking into account at least one measurement signal, which is dependent on an electrical voltage or capacitance between the suspended measuring electrode and the single measuring counter electrode or at least one of the measuring counter electrodes, and the internal pressure and/or the change in the internal pressure.

As already discussed above, a first semiconductor and/or metal layer can be deposited onto a substrate surface of a substrate as part of the housing component and/or at least one intermediate layer which at least partially covers the substrate surface, and at least one first counter electrode and a first measuring counter electrode can be structured out of the first semiconductor and/or metal layer. Likewise, a second semiconductor and/or metal layer can be deposited on the first semiconductor and/or metal layer and/or at least one first sacrificial layer which at least partially covers the first semiconductor and/or metal layer, so that the at least one electrode structure and the suspended measuring electrode can be structured out of the second semiconductor and/or metal layer. A third semiconductor and/or metal layer can furthermore be deposited on the second semiconductor and/or metal layer and/or at least one second sacrificial layer which at least partially covers the second semiconductor and/or metal layer and at least one second counter electrode and a second measuring counter electrode can be structured out of the third semiconductor and/or metal layer. If desired, a fourth semiconductor and/or metal layer can be deposited on the third semiconductor and/or metal layer and/or at least one third sacrificial layer which at least partially covers the third semiconductor and/or metal layer and the membrane can be formed from the fourth semiconductor and/or metal layer.

The method steps St1 to St3 can be carried out in any order, overlapping in time or simultaneously.

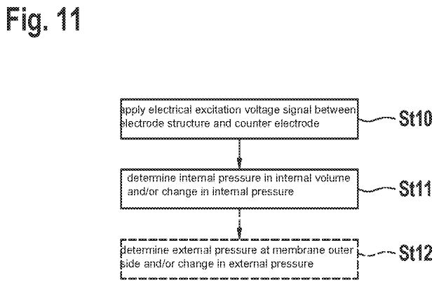

FIG. 11 shows a flow chart for explaining an embodiment of a method for measuring an internal pressure in a gas-tight internal volume of a housing component.

When carrying out the here-described method, as method step St10, at least one electrical excitation voltage signal is applied between at least one electrode structure which is disposed in the internal volume in an adjustable and/or bendable manner and at least one counter electrode which is fixedly disposed on and/or in the housing component, such that the at least one electrode structure is set in an oscillating motion relative to the housing component.

Subsequently, as method step St11, the internal pressure in the internal volume and/or a change in the internal pressure are detected and/or determined while taking into account at least one sensor signal which is dependent on an electrical voltage or capacitance between the at least one adjustable or bendable electrode structure and the single counter electrode or at least one of the counter electrodes. As already explained above, the internal pressure in the internal volume can be reliably determined using method steps St10 and St11.

Method steps St10 and St11 can in particular be used to measure the internal pressure and/or a change in the internal pressure in a gas-tight internal volume of a housing component comprising a deformable membrane, the membrane inner side of which adjoins the internal volume with a measuring electrode which is suspended on the membrane inner side. As an optional method step St12, the external pressure at a membrane outer side of the membrane facing away from the membrane inner side and/or a change in the external pressure can be detected and/or determined/measured while taking into account at least one measurement signal, which is dependent on an electrical voltage or capacitance between the suspended measuring electrode and at least one measuring counter electrode which is fixedly disposed on and/or in the housing component, and the internal pressure and/or the change in the internal pressure.

1-11. (canceled)

12. A sensor device, comprising:
a housing component with a gas-tight internal volume configured therein;
at least one electrode structure disposed in the internal volume in an adjustable and/or bendable manner;
at least one counter electrode fixedly disposed on and/or in the housing component; and
an electronic device configured to apply at least one electrical excitation voltage signal between the at least one adjustable and/or bendable electrode structure and at least one of the at least one counter electrode such that the at least one electrode structure is set in an oscillating motion relative to the housing component;
wherein the electronic device is configured to detect and/or determine an internal pressure in the internal volume and/or a change in the internal pressure while taking into account at least one sensor signal which is dependent on an electrical voltage or capacitance between the at least one adjustable and/or bendable electrode structure and the at least one of the at least one counter electrode.

13. The sensor device according to claim 12, wherein the housing component includes a deformable membrane with a membrane inner side which adjoins the internal volume, and the sensor device includes a measuring electrode which is suspended on the membrane inner side, and at least one measuring counter electrode which is fixedly disposed on and/or in the housing component, and wherein the electronic device is additionally configured to detect or determine an external pressure at a membrane outer side of the membrane facing away from the membrane inner side and/or a change in the external pressure, while taking into account at least one measurement signal, which is dependent on an electrical voltage or capacitance between the suspended measuring electrode and the at least one of the at least one measuring counter electrode, and the determined internal pressure and/or the determined change in the internal pressure.

14. The sensor device according to claim 13, wherein, as the at least one counter electrode, the sensor device includes a respective first counter electrode disposed on a side of the at least one adjustable and/or bendable electrode structure facing away from the membrane adjacent to the at least one electrode structure and a respective second counter electrode disposed on a side of the at least one electrode structure facing the membrane adjacent to the at least one electrode structure, and wherein the electronic device is configured to form a difference signal between a first sensor signal, which is dependent on a first electrical voltage or capacitance between the at least one electrode structure and the first counter electrode, and a second sensor signal, which is dependent on a second electrical voltage or capacitance between the at least one electrode structure and the second counter electrode.

15. The sensor device according to claim 14, wherein, as the at least one measuring counter electrode, the sensor device includes a first measuring counter electrode disposed on a side of the suspended measuring electrode facing away from the membrane adjacent to the suspended measuring electrode and a second measuring counter electrode disposed on a side of the suspended measuring electrode facing the membrane adjacent to the suspended measuring electrode, and wherein the electronic device is configured to form a difference measurement signal between a first measurement signal, which is dependent on an electrical voltage or capacitance between the suspended measuring electrode and the first measuring counter electrode, and a second measurement signal, which is dependent on an electrical voltage or capacitance between the suspended measuring electrode and the second measuring counter electrode.

16. The sensor device according to claim 15, wherein the housing component includes a substrate, the at least one first counter electrode and the first measuring counter electrode are structured out of a first semiconductor and/or metal layer deposited on a substrate surface of the substrate and/or at least one intermediate layer which at least partially covers the substrate surface, the at least one adjustable and/or bendable electrode structure and the suspended measuring electrode are structured out of a second semiconductor and/or metal layer deposited on the first semiconductor and/or metal layer and/or at least one first sacrificial layer which at least partially covers the first semiconductor and/or metal layer, the at least one second counter electrode and the second measuring counter electrode are structured out of a third semiconductor and/or metal layer deposited on the second semiconductor and/or metal layer and/or at least one second sacrificial layer which at least partially covers the second semiconductor and/or metal layer and the membrane is formed from a fourth semiconductor and/or metal layer deposited on the third semiconductor and/or metal layer and/or at least one third sacrificial layer which at least partially covers the third semiconductor and/or metal layer.

17. The sensor device according to claim 12, wherein, in an acceleration and/or rotation rate measurement mode, the electronic device is configured to determine at least one sensor variable relating to the acceleration and/or the rotation rate of the sensor device during an acceleration and/or rotation of the sensor device taking into account the at least one sensor signal.

18. A method for producing a sensor device, comprising the following steps:
forming at least one electrode structure of the sensor device, the at least one electrode structure being disposed in an adjustable and/or bendable manner in an internal volume of a housing component of the sensor device;
forming at least one counter electrode of the sensor device, the at least one counter electrode being fixedly disposed on and/or in the housing component;
closing off the internal volume in a gas-tight manner; and
forming an electronic device of the sensor device, the electronic device being configured to apply at least one electrical excitation voltage signal between the at least one adjustable or bendable electrode structure and at least one of the at least one counter electrode such that the at least one electrode structure is set in an oscillating motion relative to the housing component,
wherein the electronic device is additionally configured to detect or determine an internal pressure in the internal volume and/or a change in the internal pressure, while taking into account at least one sensor signal which is dependent on an electrical voltage or capacitance between the at least one adjustable and/or bendable electrode structure and the at least one of the at least one counter electrode.

19. The production method according to claim 18, wherein a deformable membrane with a membrane inner side which adjoins the internal volume is configured as part of the housing component, and a measuring electrode which is suspended on the membrane inner side and at least one measuring counter electrode which is fixedly disposed on and/or in the housing component are formed, and wherein the electronic device is additionally configured to detect or determine an external pressure at a membrane outer side of the membrane facing away from the membrane inner side and/or a change in the external pressure, while taking into account at least one measurement signal which is dependent on an electrical voltage or capacitance between the suspended measuring electrode and the at least one of the at least one measuring counter electrode, and the determined internal pressure and/or the determined change in the internal pressure.

20. The production method according to claim 19, wherein a first semiconductor and/or metal layer is deposited on: a substrate surface of a substrate as part of the housing component, and/or at least one intermediate layer which at least partially covers the substrate surface, and at least one first counter electrode and a first measuring counter electrode are structured out of the first semiconductor and/or metal layer, a second semiconductor and/or metal layer is deposited on: the first semiconductor and/or metal layer, and/or at least one first sacrificial layer which at least partially covers the first semiconductor and/or metal layer, and the at least one adjustable and/or bendable electrode structure and the suspended measuring electrode are structured out of the second semiconductor and/or metal layer, a third semiconductor and/or metal layer is deposited on: the second semiconductor and/or metal layer, and/or at least one second sacrificial layer which at least partially covers the second semiconductor and/or metal layer, and at least one second counter electrode and a second measuring counter electrode are structured out of the third semiconductor and/or metal layer, and wherein a fourth semiconductor and/or metal layer is deposited on: the third semiconductor and/or metal layer, and/or at least one third sacrificial layer which at least partially covers the third semiconductor and/or metal layer, and the membrane is formed from the fourth semiconductor and/or metal layer.

21. A method for detecting an internal pressure/or a change in the internal pressure in a gas-tight internal volume of a housing component, comprising the following steps:
applying at least one electrical excitation voltage signal between at least one electrode structure which is disposed in the internal volume in an adjustable and/or bendable manner and at least one counter electrode which is fixedly disposed on and/or in the housing component such that the at least one electrode structure is set in an oscillating motion relative to the housing component; and
detecting or determining the internal pressure in the internal volume and/or a change in the internal pressure while taking into account at least one sensor signal which is dependent on an electrical voltage or capacitance between the at least one adjustable or bendable electrode structure and at least one of the at least one counter electrode.

22. A pressure measurement method, comprising the following steps:
determining an internal pressure and/or a change in the internal pressure in a gas-tight internal volume of a housing component including a deformable membrane, a membrane inner side of the membrane adjoins the internal volume, and a measuring electrode which is suspended on the membrane inner side; and
detecting and/or determining an external pressure at a membrane outer side of the membrane facing away from the membrane inner side and/or a change in the external pressure, while taking into account at least one measurement signal which is dependent on an electrical voltage or capacitance between the suspended measuring electrode and at least one measuring counter electrode which is fixedly disposed on and/or in the housing component, and the determined internal pressure and/or the determined change in the internal pressure.
